(19) United States
(12) Patent Application Publication
(10) Pub. No.: US 2026/0288197 A1
(43) Pub. Date: Sep. 24, 2026

(54) SYSTEMS AND METHODS FOR IMPROVING CLOCK ACCURACY

(71) Applicant: TEXAS INSTRUMENTS INCORPORATED, Dallas, TX (US)

(72) Inventor: Michael Zwerg, Dallas, TX (US)

(21) Appl. No.: 19/194,324

(22) Filed: Apr. 30, 2025

Related U.S. Application Data
(60) Provisional application No. 63/775,385, filed on Mar. 21, 2025.

(51) Int. Cl. G06F 1/12

(52) U.S. Cl. CPC G06F 1/12

(57) ABSTRACT

Devices and methods for a Clock Data Recovery circuit that includes a feedback circuit, a low-cost oscillator, and a reference clock. Due to design and environmental variations and imperfections, the oscillator may generate a clock with a frequency that may be deviated from a predetermined frequency. Based on the reference clock, the feedback circuit may detect how deviated the frequency of the clock generated may be from the predetermined frequency by comparing how many clock cycles of the clock generated has elapsed during a reference time window with a reference number, which is the number of clocks would have elapsed if the clock is running at the predetermined frequency. Based on the deviation, the feedback circuit may adjust parameters of the oscillator to adjust the frequency of the clock generated. The clock generated may continuously be monitored and adjusted by the feedback circuit to achieve desired accuracy.

### BACKGROUND

Many commonly used communication interfaces are able to communicate despite differences in clocking even without exchanging shared clock signals between the communicating devices. Universal Serial Bus (“USB”) is one such communication interface. USB refers broadly to a family of industry protocols that define communication interfaces for data exchange and delivery of power between computers, peripherals, and other electronic devices. A USB host (for example, a computer) may initiate communication to a USB device, when the USB device is connected to the USB host via USB connectors/cables. The USB host may detect, manage power distribution, and send commands to the USB device. The USB device (for example, a keyboard, a mouse, a printer, or other peripheral devices) may respond to the commands sent by the USB host. Some electronic devices may act as either host and/or device.

The USB 2.0 specification, incorporated here by reference, describes that the USB host and the USB device communicate by a differential pair of data signals (D+ and D−), but the specification does not require the USB host to share clock signals with the USB device for use in sampling the data signals. The lack of shared clock signals between the USB host and the USB device may pose challenges for data transfers.

### SUMMARY

Disclosed herein is technology, including systems, methods, and devices, for data verification and protection. Many embodiments of this disclosure include a device. The device may include a USB controller, an oscillator, and a feedback circuit. The feedback circuit may receive a reference clock either derived from the Start of Frame (SOF) packets sent from the USB host or derived from a low-frequency oscillator. The feedback circuit may also receive the USBCLK generated by the oscillator. The feedback circuit may count a number of cycles of the USBCLK during a number of cycles (e.g., 1) of the reference clock (reference time window). If the reference clock has a fixed frequency, the oscillator is designed to have a fixed predetermined frequency, and the number of cycles of the reference clock during the reference time window is fixed, a reference number may be a fixed number and stored in a memory. If the reference clock and the USBCLK have programmable/variable frequency and/or the reference time window may not be fixed, a computing circuit may compute the reference number to be stored in a memory. The reference number may be forwarded to the feedback circuit from the memory where the reference number is stored. The counted number of cycles of the USBCLK may be compared with the reference number to assess how deviated the frequency of the USBCLK is from the predetermined frequency. Based on the offset (the difference between the counted number of cycles of the USBCLK and the reference number), the feedback circuit may send control signals to the oscillator to adjust the frequency of the USBCLK.

The oscillator may be a resistor-capacitor (RC) oscillator that may include two variable resistors (a first variable resistor and a second variable resistor) and a capacitor. The frequency of the USBCLK generated may be determined by the resistance of the variable resistors. Resistance of the first variable resistor may be set by a trimming process during production tests at the manufacturer, and the capacitance may also be set. To adjust the frequency of the USBCLK (equivalent of increasing or decreasing durations of individual cycles), the feedback circuit may send control signals to adjust the resistance of the second variable resistor based on the offset. The second variable resistor may include a set of switches and a set of resistors, and opening and/or closing the set of switches may determine the resistance of the second variable resistor. To further improve the USBCLK accuracy, the feedback circuit may send control signals to close a first switch of the set of switches for a first number of clock cycles of the USBCLK, to open the first switch and to close a second switch for a second number of clock cycles of the USBCLK, and to close a third switch for the first and second number of clock cycles of the USBCLK. The resistance of the second variable resistor may vary from cycle to cycle, thus frequency of the USBCLK may vary from cycle to cycle, which may be equivalent of increasing and/or decreasing the durations of cycles from cycle to cycle. The modulation techniques (evening out the frequency change in a number of cycles) may help improve the USBCLK accuracy. The USBCLK generated by the oscillator may continuously be fed back to the feedback circuit, so the USBCLK may be continuously monitored and adjusted if deviated from the predetermined frequency.

Many embodiments of this disclosure include a method of improving clock accuracy generated by a low-cost non-crystal oscillator. The method may include receiving the reference clock either derived from the SOF packets sent by the USB host or derived from a low-frequency oscillator internal or external to the USB device. The method may also include generating the USBCLK with a starting frequency by the oscillator. The method may further include reading the reference number stored in a memory, either fixed or programmable. The method may include counting how many cycles of the USBCLK elapsed during a time period (reference time window). The reference time window is based on a number of cycles of the reference clock. The method may include comparing the counted number of cycles of the USBCLK with the reference number and determining the difference (offset) between the counted number and the reference number. The method may include adjusting durations of a set of cycles of the USBCLK (adjust frequency of a set of cycles of the USBCLK) based on the difference (offset).

### BRIEF DESCRIPTION OF THE DRAWINGS

FIG. 1 is a block diagram that illustrates an example system of an example USB device communicating with an example USB host in accordance with many embodiments.

FIG. 2 is a block diagram that illustrates further details of an example USB device in accordance with many embodiments.

FIG. 3 is a timing diagram that illustrates a set of example waveforms of the USBCLK with adjusted frequencies based on different offsets in accordance with many embodiments.

FIG. 4 is a circuit diagram that illustrates further details of an example oscillator in accordance with many embodiments.

FIG. 5 is a circuit diagram that illustrates further details of an example variable resistor included in the example oscillator in accordance with many embodiments.

FIG. 6 is a circuit diagram that illustrates the example variable resistor including a set of MOSFETs as switches in accordance with many embodiments.

FIG. 7 is a circuit diagram that illustrates details of the example variable resistor having a different configuration in accordance with many embodiments.

FIG. 8 is a circuit diagram that illustrates the example variable resistor with the different configuration including a set of MOSFETs as switches in accordance with many embodiments.

FIG. 9 is a flow diagram that illustrates a process for improving clock accuracy with an example low cost, non-crystal oscillator in accordance with many embodiments.

The same reference numbers or other reference designators are used in the drawings to designate the same or similar (functionally and/or structurally) features.

### DETAILED DESCRIPTION

As described above, the USB interface between a USB host and a USB device may not communicate shared clock signals. However, data transfers between the USB host and device may be synchronous for data integrity. The USB specification defines data transfer parameters for both the USB host and the USB device, such as data rate accuracy and clock jitter/drift tolerances for synchronous data transfers. USB hosts and USB devices that comply to the data transfer parameters and protocols defined by the USB specification may be characterized as USB-compliant. In many examples, the USB host may include a clock source and transmit sets of data based on the clock source, and the USB device may also include a similar clock source, such as a high-frequency crystal oscillator and/or implement Phase Locked Loop (PLL), to sample the received signals to recover the sets of data from the USB host in a USB-compliant manner. Additionally, or in the alternative, the USB device may include Clock Data Recovery (CDR) circuits or other synchronization techniques in place of a traditional clock source to sample the received signals and thereby receive data to/from the USB host in a USB-compliant manner. Many embodiments of this disclosure which are described in more details below include a low-cost CDR circuit with a low-cost non-crystal oscillator.

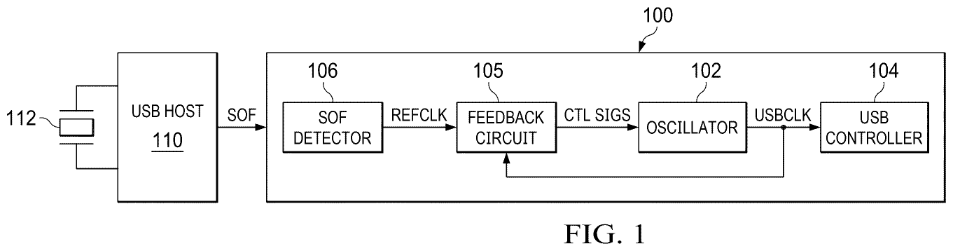

FIG. 1 is a block diagram illustrating a USB device 100 capable of extracting timing information of a USB host 110 based on Start-of-Frame (SOF) packets in accordance with many embodiments of this disclosure.

The USB host 110 and the USB device 100 shown in FIG. 1 may be system-on-chips (SOCs) or any other integrated circuit devices/systems that may be configured to communicate using the USB protocol. The USB host 110 may couple to a crystal 112 and use the clock signals generated by the crystal 112 to transmit data to the USB device 100. In many examples, the crystal 112 may be external to the USB host 110, although in other examples, the crystal 112 may be integrated with the USB host 110 in the same package of an integrated circuit. The USB 2.0 specification defines three signaling bit rates: the low-speed bit rate which is 1.5 megabits per second (Mb/s), the full-speed bit rate which is 12 Mb/s, and the high-speed bit rate which is 480 Mb/s. The USB host 110 operating with low-speed or full-speed bit rate may transmit a Start of Frame (SOF) packet every 1 ms and may transmit the SOF packet every 125 microsecond (us) if operating with high-speed bit rate, and the SOF packets may be generated and transmitted based on the clock signals generated by the crystal 112. The SOF packet may be 24 bits long with an 8-bit packet identifier field, a 11-bit frame number field, and a 5-bit cyclic redundancy check (CRC) field. The format of the SOF packet is defined in the USB 2.0 specification.

A SOF detector 106 in the USB device 100 may receive the SOF packets and derive a reference clock based on the received SOF packets from the USB host 110. For example, the SOF packets may be sampled at the eighth bit. When the SOF detector 106 samples the eighth bit of a SOF packet, the SOF detector 106 may start a reference clock cycle of a reference clock signal, REFCLK. When the SOF detector 106 receives the eighth bit of the next SOF packet, the SOF detector 106 may end the current reference clock cycle and may start the next reference clock cycle. When operating with full-speed bit rate, the USB host 110 may transmit a SOF packet every 1 ms, by sampling at the same bit of the SOF packet, the USB device 100 may derive a 1 kHz signal for REFCLK based on the SOF packets received from the USB host 110.

The USB device 100 may include a USB controller 104 which handles core functions for USB communications, such as supporting enumeration, data management/transmission, and different data transfer modes. To perform those core functions, the USB controller 104 may operate with a clock at the data bit rate, which is higher than the REFCLK derived from the SOF packets. The USB controller 104 may further sample multiple times per data bit and may operate with a higher frequency clock than the data bit rate to perform those core functions. For example, the USB controller 104 may sample 5 times per data bit. At full-speed, one data bit period is 83 μs (12 Mb/s), and the USB controller 104 may sample every 16.6 us and therefore operate with a 60 MHz clock (USBCLK).

In some embodiments, the USB device 100 may include a high-frequency crystal or a PLL circuit to generate a high frequency clock with desired precision as the USBCLK. However, high-frequency crystals or PLL circuits may take up significant device space and hence may be expensive to implement. Alternatively, the USB device 100 may include an oscillator 102, (for example, a resistor-capacitor (RC) oscillator), which may take up less device space and low-cost, to generate the USBCLK of a predetermined frequency. However, the oscillator 102 may not generate clocks of precisely the predetermined frequency to support the USB controller 104 to achieve the desired accuracy level of the data bit rate. For example, the USB 2.0 specification defines a data bit accuracy of 12 Mb/s+/−0.25% (bit rate may vary from 11.97 Mb/s to 12.03 Mb/s) for full-speed operations. Accordingly, the USBCLK may be provided to a feedback circuit 105 that may measure how deviated the frequency of the USBCLK is from the predetermined frequency and send control signals to the oscillator 102 to adjust the frequency of USBCLK accordingly. The feedback circuit 105 may continuously receive the USBCLK generated by the oscillator 102 as input and may keep monitoring how deviated the frequency of the USBCLK generated by the oscillator 102 is from the predetermined frequency using the reference clock signal REFCLK. When the frequency of the USBCLK deviates from the predetermined frequency, the feedback circuit 105 may detect the deviation and adjust the frequency of the USBCLK accordingly. The feedback circuit 105 and the oscillator 102 are described in more details later.

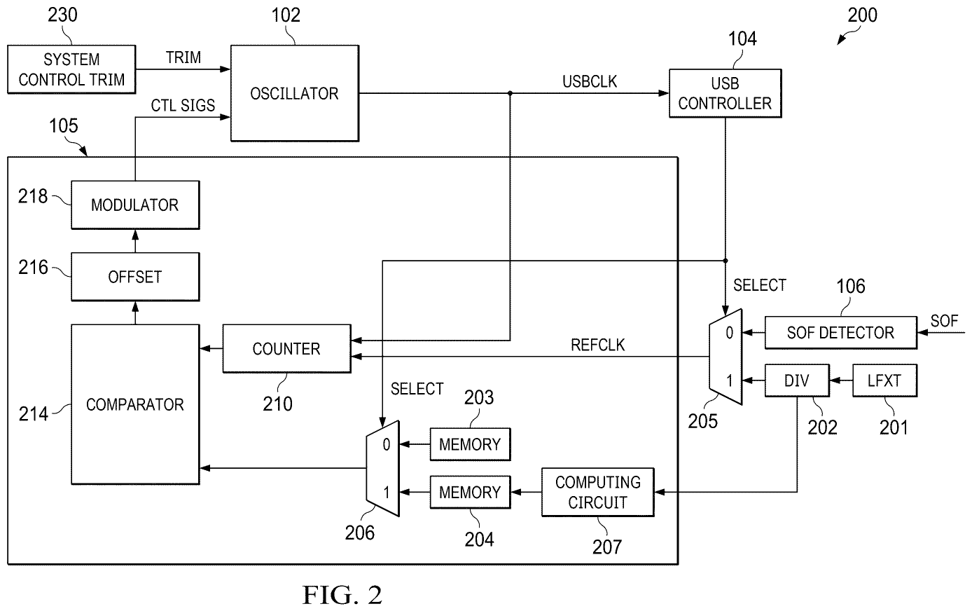

FIG. 2 is a block diagram illustrating details of a USB device 200. The USB device 200 described in FIG. 2 may be similar to the USB device 100 unless otherwise described herein. The USB device 200, similar to the USB device 100, may receive the SOF packets from the USB host 110 to derive the reference clock, REFCLK, as described above. Alternatively, the USB device 200 may include a low-frequency crystal 201 which may provide a low-frequency clock. The low-frequency crystal 201 may not provide a clock with the desired frequency of the REFCLK. A divider circuit 202 may be implemented to divide the low-frequency clock generated by the low-frequency crystal 201 to provide the REFCLK with the desired frequency. For example, the low-frequency crystal 201 may provide a 32 kHz clock and the desired frequency of the REFCLK is 1 kHz. The divider circuit 202 may receive the 32 kHz clock from the low-frequency crystal 201 and divide the 32 kHz clock by 32 to provide a 1 kHz clock as the REFCLK. The clock generated by the low-frequency crystal 201 may also serve multiple communication interfaces included in the USB device 200. For example, a universal asynchronous receiver-transmitter (UART) interface may also receive the 32 kHz clock generated by the low-frequency crystal 201 as reference clock. Depending on the desired frequencies of different communication interfaces, respective divider circuits may be implemented. By implementing one low-frequency crystal 201 for multiple communication interfaces, more device space may be saved.

In some other examples, the USB device 200 may include both the 1 kHz clocks derived from the SOF packets sent by the USB host 110 and from the low-frequency clock provided by the low-frequency oscillator 201. The USB device 200 may include a mux 205 to receive both the 1 kHz clocks. The USB controller 104 or a central processing unit or other control units in the USB device 200 may send a select signal to the mux 205 to select one of the 1 kHz clocks (derived from SOF packets or derived from the low-frequency oscillator 201) to be the REFCLK. The mux 205 is shown in FIG. 2 as a two-input mux. In some other embodiments, the mux 205 may have any number of inputs. Clock sources internal to the USB device 200 may generate clocks to be provided to the inputs of the mux 205 and/or the USB device 200 may receive clocks from external clock sources to provide to the inputs of the mux 205. The USB controller 104 or other control units in the USB device 200 may select any clocks available as the REFCLK.

The feedback circuit 105 in the USB device 200 may include a counter 210. The counter 210 may receive the REFCLK from the mux 205 or directly from clock sources and the USBCLK generated by the oscillator 102. The oscillator 102 is described in more details later. The counter 210 may count how many clock cycles of the USBCLK elapsed during a reference time window, where the reference time window may be the time period of a number of cycles of the REFCLK. For example, the reference time window may be one cycle of the REFCLK, and the counter 210 may count how many cycles of the USBCLK elapsed during one clock cycle of the REFCLK (the reference time window). The counter 210 may be triggered to count at the start of the reference time window (e.g., either rising edge or falling edge of a first cycle of the REFCLK). The counter 210 may start at 0 and increment 1 at each rising or falling edge of the USBCLK. The counter 210 may stop counting (or otherwise store the current count) when the reference time window ends and a next reference window starts (e.g., either the rising or falling edge of a second cycle of the REFCLK). The counter 210 may record and forward the counted number of cycles of the USBCLK during the reference time window to a comparator 214. The comparator 214 is described later. The counter 210 may also clear the counted number subsequently after the counted number has been forwarded and may start at 0 again and count the number of cycles of the USBCLK during the next reference time window. For example, the REFCLK of 1 kHz may have a period of 1 ms (the reference time window is 1 ms). If the USBCLK is operating at a perfect frequency of 60 MHz, during each reference time window (1 ms), the counter 210 may count 60,000 clock cycles of the USBCLK. In other example, the reference time window may include any number of cycles of the REFCLK.

In many scenarios, clocks may not be ideal. Noises, power glitches, and other disturbances may cause clock jitter (variation in timing from cycle to cycle). Temperatures, humidity, capacitor degradation and other hardware components imperfections may cause clock drift (variation in frequency). Using the example above, if the USBCLK is clocking at a precise frequency of 60 MHz, during 1 ms of time, 60,000 cycles of the USBCLK may elapse. However, because of many environmental variations and hardware imperfections, the USBCLK may not have a perfect 60 MHz clock, thus the counter 210 may not count exactly 60,000 clock cycles of USBCLK in one period of the REFCLK.

To determine how deviated the frequency of the USBCLK generated by the oscillator 102 is from the predetermined frequency of the REFCLK, the comparator 214 may receive the counted number of cycles of the USBCLK from the counter 210 and compare the counted number to a reference number of how many clock cycles of USBCLK would elapse if the USBCLK is operating at the predetermined frequency. For example, if the predetermined frequency of USBCLK is 60 MHz, and the reference time window is 1 ms (1 cycle of the reference clock derived from the SOF packets), the reference number may be 60,000. If counter 210 is upcounting and overflows (e.g., exceeds the reference number before the end of the REFCLK cycle, the USBCLK frequency may be decreased, and if the counter does not reach the reference number before the end of the REFCLK cycle, the USBCLK frequency may be increased, as explained below. Likewise, if counter 210 is downcounting starting at the reference number underflows (e.g., goes below 0 before the end of the REFCLK cycle, the USBCLK frequency may be decreased, and if the counter does not reach 0 before the end of the REFCLK cycle, the USBCLK frequency may be increased, as explained below. The REFCLK may be of any desired frequency, and the USBCLK, may also be of any predetermined frequency depending on many factors, such as sampling rates of the USB controller 104. Depending on the frequency of the REFCLK, the predetermined frequency of the USBCLK, and the number of cycles of the REFCLK in the reference window, the reference number may vary. For example, if the REFCLK derived from the low-frequency crystal 102 is selected, the low-frequency crystal 102 may provide a clock with a frequency of 32.768 kHz. After the clock is divided by 32, the REFCLK may be 1.024 kHz (each clock cycle is approximately 0.977 ms). In such a case, the reference number may be 58,594.

In some embodiments the reference number may be a fixed number that is preprogrammed and stored in a memory 203 (e.g., the REFCLK is derived from SOF packets and the USB controller 104 may have a fixed oversampling rate (e.g., 5)). The USB controller 104 or a memory controller may read the reference number from the memory 203 and provide the reference number to the comparator 214 when requested (e.g., the counter 210 starts counting the USBCLK clock cycles).

Additionally, or alternatively, the USB device 200 may include a computing circuit 207 to calculate the reference number in embodiments where the reference number may not be a fixed number. For example, if the divider circuit 202 or the low-frequency oscillator 201 is programmable, the frequency of the REFCLK may vary. The computing circuit 207 may receive the frequency of the REFCLK from respective clock source/divider circuit and/or from the USB controller 104 and calculate the reference number based on the predetermined frequency of the USBCLK, the frequency of the REFCLK, and how many cycles of the REFCLK may be in the reference time window, during which the counter 210 may be counting the USBCLK cycles. The computing circuit 207 may calculate the reference number by multiplying the predetermined frequency of the USBCLK (fUSBCLK) and the number of clock cycles of the REFCLK during which the counter 210 is counting the USBCLK clock cycles (tREFCLK), and then divide the product by the frequency of the REFCLK (fREFCLK), shown in equation form below.

$$reference number = \frac{fUSBCLK \times tREFCLK}{fREFCLK}$$

Using the example above, if the REFCLK is 1.024 kHz, the predetermined frequency of the USBCLK is 60 MHz, and the counter 210 is counting the number of cycles of the USBCLK during one cycle of the REFCLK, the computing circuit 207 may calculate the reference number by substituting the numbers to the respective fields in the equation above,

$$\frac{60 MHz \times 1}{1.024 kHz} ,$$

which is approximately 58,594. The computing circuit 207 may store the reference number in a memory 204 or any other registers or memories including the memory 203 after the calculation.

In embodiments where multiple clock sources are providing clocks to the mux 205, multiple respective reference numbers may be stored in either registers or memories. Depending on which clock is selected through the mux 205 as the REFCLK, the respective reference number may be selected to be read and be provided to the comparator 214 through a mux 206. The select signal from the USB controller 104 or other controlling units in USB device 200 to the mux 205 may also be forwarded to the mux 206 to select the respective reference number. For example, the REFCLK derived from the SOF packets may be provided to the input 0 of the mux 205, and the respective reference number, 60,000, may be provided to the input 0 of the mux 206. When the USB controller 104 or other controlling units send a 0 on the select signal, both the REFCLK derived from the SOF packets and its respective reference number may be selected. The REFCLK derived from the low-frequency oscillator 201 may be programmable and provided to the input 1 of the mux 205, and the respective reference number may be calculated as described above by the computing circuit 207 and provided to the input 1 of the mux 206. When the USB controller 104 or other controlling units send a 0 on the select signal, both the REFCLK derived from the SOF packets and its respective reference number may be selected. In some examples, the reference number, if a fixed number, may be stored in the memory 203. The reference number, if calculated by the computing circuit 207, may be stored in the memory 204. In other examples, the memory 203 and the memory 204 may be cache registers of any levels, and/or any types of memory that may include any volatile, non-volatile, magnetic, or electrical media, such as a dynamic random-access memory (DRAM), non-volatile RAM (NVRAM), electrically-erasable programmable ROM (EEPROM), flash memory, hard disks, or any other digital media. Memory 203 and 204 may be the same memory type and may be included in the same memory module. Memory 203 and 204 may also be separate memories with different memory types.

The comparator 214 may receive the counted number of USBCLK cycles from the counter 210 and the reference number either directly from a register, a memory, or from the output of the mux 206. The comparator may compare the two numbers by subtracting the reference number from the counted number. If the counted number is bigger than the reference number, the difference may be recorded as a positive integer by the comparator 214 and the USBCLK may be operating at a higher frequency than the predetermined frequency. If the counted number is smaller than the reference number, the difference may be recorded as a negative integer by the comparator 214 and the USBCLK may be operating at a slower frequency than the predetermined frequency. The positive or negative signs of the integer may represent if the USBCLK is faster or slower respectively than the predetermined frequency. The magnitude of the integer may represent the magnitude of how deviated the frequency of the USBCLK is from the predetermined frequency. The bigger the magnitude of the integer may be, the more deviated the frequency of the USBCLK may be from the predetermined frequency.

In some embodiments, the counter 210 may receive the reference number from a memory directly or from the output of the mux 206. The counter 210, instead of counting from 0, may count down from a sum, which is the reference number plus an overflow number. The counter 210 may subtract 1 from the sum each cycle of the USBCLK elapsed. The counter 210 may record the counted down number (the number the counter 210 counted down to from the sum when the counter 210 stops counting) and subtract the overflow number from the counted down number as a result. If the USBCLK is running slower than the predetermined frequency, the result may be a positive number. If the USBCLK is running faster than the predetermined frequency, the result may be a negative number. In some examples, to be consistent with the examples where the comparator 214 may be used as described above, the sign of the result may be flipped (e.g., a negative integer when the result is positive, and a positive integer when the result is positive) to provide to the offset circuit 216. The overflow number may be determined based on how deviated the frequency of the USBCLK generated may be from the predetermined frequency. For example, if in the worst-case, the USBCLK generated by the oscillator 102 without adjustment may be 59 MHz or 61 MHz, the overflow number may be 1000. Alternatively, the overflow number may be a large enough number (e.g., the overflow number may be the reference number) to make sure the counter 210 may not overflow (e.g., the counter 210 counts to 0 and continues to count down). In this manner, the counter 210 may provide the integer as the difference between the counted number and the reference number directly to the offset circuit 216 without the comparator 214.

The offset circuit 216 may receive a set of signals based on the integer (the difference between the counted number of USBCLK cycles and the reference number) from the comparator 214 or directly from the counter 210. In some examples, the set of signals are sufficient to specify any measurable difference between the counted number USBCLK cycles and the reference number, and in other examples, the set of signals are limited and only specify a subset of possible differences (e.g., only coarse+/−10 and fine+/−1 differences). In either case, based on these signals and likewise based on the magnitude of the integer, the offset circuit 216 may estimate a frequency of the USBCLK generated and provide an offset to a modulator 218 based on how much the frequency of the USBCLK generated deviates from the predetermined frequency. Based on the offset received, the modulator 218 may send control signals to the oscillator 102 to adjust the frequency of the USBCLK. Since the counter 210 counts the USBCLK cycles during the reference time window, the frequency of the USBCLK derived in this manner may be the average frequency of the USBCLK during the reference time window. For example, if the reference number is 60,000 (60 MHz of predetermined frequency) and the counter 210 counts 59,000 cycles during the reference time window, the frequency of the USBCLK may be derived as 59 MHz, which is the average frequency of the USBCLK over 59,000 cycles. Individual USBCLK cycles within the 59,000 cycles may have different frequencies. Depending on how the frequencies of individual USBCLK cycles are distributed (e.g., where individual frequencies are with respect to the average frequency) within the reference time window, different analysis may be taken regarding the accuracy of the USBCLK. Many design parameters, such as the configurations of the oscillator 102 and processes used to fabricate the USB device 100 and/or 200, may have impact on the distribution of the individual frequencies. The following embodiments are described assuming the frequencies of the individual USBCLK cycles have a normal Gaussian distribution (majority of the individual frequencies near the average and all of the individual frequencies symmetrical about the average) with negligible variance during the reference time window.

Due to design space constraints, configuration, fabrication process, and other factors, the oscillator 102 may be limited to a frequency adjustment step. The frequency adjustment step of the oscillator 102 is described in more details later. The frequency adjustment step of the oscillator 102 may be the smallest frequency adjustment of the USBCLK. For example, if the oscillator 102 has a frequency adjustment step of 0.6%, the frequency of the USBCLK may be adjusted in steps of 0.6%. The frequency may be adjusted by multiples of 0.6%. If 60 MHz is the predetermined frequency of the USBCLK and the frequency of the USBCLK generated by the oscillator 102 is 58 MHz, the frequency of the USBCLK may be adjusted to 59.8 MHz (58+60×5×0.6%) or 60.16 MHz (58+60×6×0.6%). The frequency adjustment step may determine how accurate the final adjusted frequency of the USBCLK may be. Using the example above where the frequency adjustment step may be 0.6%, the final adjusted frequency of the USBCLK may range from 60 MHz+/−0.3% (+/−0.18 MHz). The above relationship described between the frequency adjustment step and the final adjusted frequency accuracy assumes the normal Gaussian distribution of the individual frequencies within the reference time window as described above. If the individual frequencies exhibit a different distribution within the reference time window, the frequency adjustment step (e.g., 0.6%) may result in a different final adjusted frequency range of the USBCLK. Example embodiments are described later with more details on the structure of the oscillator 102, how the modulator 218 send control signals to the oscillator 102 to adjust the frequency of the USBCLK, and factors that may affect the frequency adjustment step of the oscillator 102.

The frequency adjustment step may limit the USBCLK from exactly achieving the desired data rate accuracy requirement. The USB 2.0 specification defines the data rate accuracy to be +/−0.25%. Using the above example, the frequency adjustment step of the oscillator 102 of 0.6%, which limits the accuracy of the final adjusted frequency of the USBCLK, (e.g., limits the data rate accuracy) may limit the data rate accuracy to be only +/−0.3%. To further improve the USBCLK frequency accuracy and the data rate accuracy, the modulator 218 may implement further modulation techniques on the control signals sent to the oscillator 102 to achieve an equivalent frequency adjustment step that may be smaller than the frequency adjustment step, and thus better accuracy for the final adjusted frequency of the USBCLK and data rate accuracy.

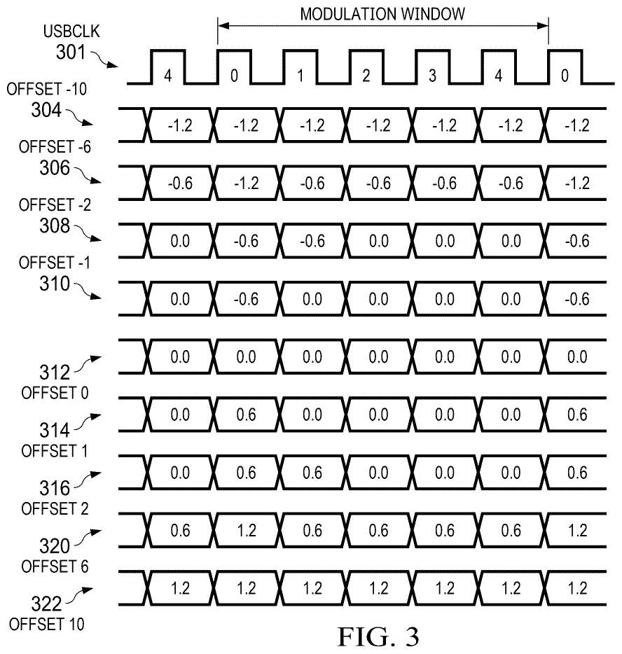

In many embodiments, the oscillator 102 may generate the USBCLK with a starting frequency, and the modulator 218 may adjust the starting frequency of the USBCLK for a number of cycles (e.g., by increasing or decreasing durations of the number of cycles) and keep the rest of the cycles at the starting frequency (e.g., by keeping the durations the same of the rest of the cycles) to achieve the equivalent frequency step of the USBCLK smaller than the frequency adjustment step, and thus better accuracy. FIG. 3 illustrates example resultant waveforms 304-322 of the USBCLK where the modulator 218 may adjust the frequency of the USBCLK for different number of cycles based on the different offsets provided by the offset circuit 216. For example, waveform 308 in FIG. 3 illustrates an example USBCLK when offset of −2 is received. The modulator 218 may adjust the frequency of two cycles of every five-cycle data bit period to be 0.6% faster than the starting frequency (decreasing duration of two cycles of the USBCLK by 0.6% as shown in waveform 308), which is then adjusted back to the starting frequency (e.g., 0.0% faster) for three subsequent cycles so that a set of cycles that make up a data bit period (e.g., a five-cycle period) has a specified duration.

For the USBCLK to have different frequencies from one cycle to the next and the data rate not affected, the USBCLK frequency adjustments may be within each data bit period so the period of each data bit may still be uniform. The equivalent frequency adjustment step may be the frequency adjustment step of the oscillator 102 divided by the oversampling rate. For example, the USB controller 104 may have an oversampling rate of 5 as shown in FIG. 3. The USBCLK with the starting frequency (generated by the oscillator 102 before the feedback circuit 105 adjusts the frequency of the USBCLK) is shown as USBCLK waveform 301. A modulation window (1 data bit period) may include 5 cycles of the USBCLK (labeled 0-4 in FIG. 3). If each data bit period (each modulation window) is uniform, the 5 cycles of the USBCLK within each modulation window may not have the same frequency/period (frequency of the individual cycles may vary). For example, the USBCLK may have a starting frequency of 60.18 MHz (60 MHz+0.3%), slightly faster than the predetermined frequency of 60 MHz. The respective data rate may be 12.036 MHz (12 MHz+0.3%). If the modulator 218 adjusts the frequency/period of the first clock cycle of each modulation window to be 59.82 MHz (60.18 MHz-60 MHz×0.6%) and keeps the frequency of the four subsequent clock cycles to be 60.18 MHz, and the respective data rate may be 12.0215 MHz (12 MHz+0.18%). The respective resultant waveform is illustrated as waveform 314 in FIG. 3. If the modulator 218 adjusts the frequency of the first 2 clock cycles of each modulation window to be 59.82 MHz and keeps the frequency of the 3 subsequent clock cycles to be 60.18 MHz, the respective data rate may be 12.007 MHz (12 MHz+0.06%), shown as waveform 316 in FIG. 3. As illustrated by the above example, by modulating frequencies of individual cycles of the USBCLK within each modulation window, the resultant equivalent frequency adjustment step of the USBCLK may be 0.12%, 5 times smaller than the frequency adjustment step of the oscillator 102, which in this example, is 0.6%. The above examples illustrate that the modulator 218 may further improve the accuracy of the final adjusted frequency of the USBCLK, and thus the data rate accuracy by modulating the frequency/period of individual cycles of the USBCLK within modulation windows.

The modulator 218 may modulate control signals based on the offset received from the offset circuit 216. In many embodiments, the offset may reflect how many equivalent frequency adjustment steps the starting frequency of the USBCLK may be adjusted. Using the example above, waveform 314 illustrates offset of 1, and the frequency adjusted by implementing an offset of 1 may be the starting frequency minus the equivalent frequency adjustment step. Similarly, waveform 316 illustrates implementing an offset of 2 and the frequency adjusted may be the starting frequency minus 2 equivalent frequency adjustment steps. As discussed above, the offset circuit 216 may receive the integer (the difference between the counted number of USBCLK cycles and the reference number) from the comparator 214 or directly from the counter 210 as an indication of how much the starting frequency may be deviated from the predetermined frequency. The offset circuit 216 may compute an offset step, which may be based on the cycles of difference between the reference number and the counted number for one equivalent frequency adjustment step. Based on the offset step, the offset circuit 216 may compute an appropriate offset to provide to the modulator 218 to indicate how many equivalent frequency adjustment steps the starting frequency may be adjusted. The offset step is computed based on the oversampling rate (n) of the USB controller 104, the frequency adjustment step of the oscillator 102 (step a %), and the reference number. The frequency adjustment step of the oscillator 102 (in percentage, e.g., 0.6%) is multiplied with the reference number, and then divided by the oversampling rate, shown in the equation below.

$$offset step = \frac{reference number \times stepa \%}{n}$$

Using the same example above where the frequency adjustment step of the oscillator 102 is 0.6%, the oversampling rate of the USB controller 104 is 5, and the reference number is 60,000, the offset step may be 72 cycles of the USBCLK and the equivalent frequency adjustment step may be 0.12%.

The offset circuit 216 may also compute a range of the received integer value for different offset values. An offset value of 0 may indicate that the frequency of the USBCLK may not be further adjusted, and the integer received by the offset circuit 216 may be between the range of +/−offset step divided by 2. Using the example above where the offset step may be 72 cycles of the USBCLK, the modulator 218 may not improve the USBCLK further when the counter 210 counts 60,000+/−36 (72/2) cycles during the reference time window, the offset circuit 216 may send an offset of 0 to the modulator 218. If the magnitude of the integer (difference between the counted number of the USBCLK clock cycles and the reference number) is less than 36, the offset circuit 216 may provide an offset of 0 to the modulator 218, and the modulator 218 may not adjust the frequency of the USBCLK generated by the oscillator 102. If the magnitude of the integer is between 36 and 108, the offset circuit 216 may provide an offset of 1 or a −1 based on whether the original frequency of the USBCLK is faster or slower respectively than the predetermined frequency. If the modulator receives an offset of 1, the modulator may modulate the control signals sent to the oscillator 102 to adjust the frequency of one cycle within a modulation window to be 0.6% slower of the starting frequency and the frequency of the rest four cycle within the modulation window of the starting frequency (equivalent of adjusting −0.12% of the starting frequency of the USBCLK). Waveform 314 illustrates this example resultant USBCLK waveform. If the modulator receives an offset of −1, the modulator may modulate the control signals sent to the oscillator 102 to adjust the frequency of one cycle within a modulation window to be 0.6% faster of the starting frequency and the frequency of the rest four cycles of the modulation window of the starting frequency. For the integer magnitude between 108 and 180, the offset circuit 216 may provide an offset of 2 or a −2. If the modulator receives an offset of 2, the modulator may modulate the control signals sent to the oscillator 102 to adjust the frequency of two cycles within a modulation window to be 0.6% slower than the starting frequency and the frequency of the rest three cycles within the modulation window of the starting frequency. The resultant USBCLK waveform is illustrated as waveform 316 in FIG. 3. If the modulator receives an offset of −2, the modulator may modulate the control signals sent to the oscillator 102 to adjust the frequency of two cycles with a modulation window to be 0.6% faster than the starting frequency and the frequency of the rest three cycles within the modulation window of the starting frequency. The resultant USBCLK waveform is illustrated as waveform 308 in FIG. 3. The offset circuit 216 may compute the range of the magnitude of the received integer corresponding to each offset value and store the results in a look up table as shown below.

| Offset magnitude | Range of integer magnitude |
|---|---|
| 0 | Less than 36 |
| 1 | 37-108 |
| 2 | 109-180 |
| 3 | 181-252 |
| 4 | 253-324 |
| 5 | 325-396 |
| 6 | 397-468 |
| 7 | 469-540 |
| 8 | 541-612 |
| 9 | 613-684 |
| 10 | Greater than 684 |

The offset circuit 216 may receive the integer from the comparator 214 or directly from the counter, look up which offset the integer may in range for and provide the respective offset to the modulator 218. The modulator 218 may modulate control signals sent to the oscillator 102 accordingly to adjust the frequency of individual cycles of the USBCLK within modulation windows.

In many examples, the offset circuit 216 may have a total of 20 steps (offset ranging from −10 to +10). If the offset provided to the modulator 218 is 6 (waveform 320 in FIG. 3), the modulator 218 may modulate control signals sent to the oscillator 102 so the adjusted frequency of the USBCLK is the starting frequency minus 6 equivalent frequency adjustment steps. For example, if the equivalent frequency adjustment step is 0.12%, the adjusted frequency of the USBCLK may be 0.72% (6×0.12%) slower than the starting frequency. As waveform 320 illustrates in FIG. 3, the frequency of the four cycles within a modulation window may be adjusted to be +0.6% slower than the starting frequency, and the one cycle of the modulation window may have a frequency+1.2% slower than the starting frequency so the adjusted frequency of the USBCLK is +0.72% slower than the starting frequency. For the magnitude of the integer greater than 684, the offset circuit 216 may provide an offset of 10 or −10. For a USBCLK that is deviated greatly from the predetermined frequency, it may take several cycles of adjusting the frequency of the USBCLK generated by the oscillator 102 to correct the deviation. For example, if the predetermined frequency is 60 MHz and the USBCLK is 58.5 MHz, the magnitude of the integer may be 1500, greater than 684. The offset circuit 216 may provide an offset of −10 to the modulator 218, and the modulator 218 may send control signals to the oscillator 102 to adjust the frequency of the USBCLK to be 59.22 MHz (58.5 MHz+1.2%×60 MHz). The USBCLK adjusted by the modulator 218 may be provided back to the counter 210, and the counter 210 may count 59,220 cycles of the USBCLK during the reference time window (1 ms). The magnitude of the integer may be 780, still greater than 684. The offset circuit 216 and the modulator 218 may adjust the USBCLK according to an offset of −10 again, and the frequency of the USBCLK may be 59.94 MHz (59.22 MHz+1.2%×60 MHz) after second adjustment. The USBCLK may be provided back to the counter 210 again as described above, and the magnitude of the integer may be 60. This time, an offset of −1 may provide an equivalent frequency of the USBCLK of 60.012 MHz. The USBCLK may continue to be provided back to the counter 210, but because the counter may count less than 36 cycles of difference (magnitude of the integer), the offset circuit 216 may provide an offset of 0 to the modulator 218 and the modulator 218 may not adjust the USBCLK further. The USBCLK of 60.012 MHz, which generates a data rate of 12 Mb/s+0.02%, may meet the data rate accuracy requirement of the USB 2.0 specification of +/−0.25%.

Alternatively, if the frequency adjustment step of the oscillator 102 varies from device to device, or a simplification of the above described algorithm for computing the offset is desired, many embodiments may compute, provide, and use the offset in a different manner as described in details below. Instead of computing the relationship between the frequency adjustment step and the integer (difference between the counted number of USBCLK and the reference number) to provide an offset value, the offset circuit 216 may be preprogrammed with a relationship between offsets provided and the integer. For example, instead of 20 offsets, the offset circuit 216 may be preprogrammed with five offset values, 10, 1, 0, −1, and −10. If the magnitude of the integer received from the comparator 214 or directly from the counter 210 is less than 60 (0.1%), an offset of 0 may be provided to the modulator 218 to indicate no further adjustment of the USBCLK. If the magnitude of the integer received is greater than 60 but less than 600, an offset of −1 or 1 may be provided, and the modulator 218 may adjust one cycle within the modulation window to be one frequency adjustment step (e.g., 0.6%) faster or slower than the starting frequency of the USBCLK generated, one equivalent frequency adjustment step. If the magnitude of the integer received is greater than 600, an offset of −10 or 10 may be provided, and the modulator 218 may adjust the frequency of all cycles within the modulation window to be two frequency adjustment step (e.g., 10 equivalent frequency adjustment steps) faster or slower than the starting frequency. In this manner, more iterations may be run before the USBCLK may be final adjusted, but the algorithm for computing and providing the offsets may be simplified. In addition, if the frequency adjustment step of the oscillator 102 may vary from device to device and/or not consistent when the modulator 218 adjusts the frequency of the USBCLK, the algorithm as described above may be implemented.

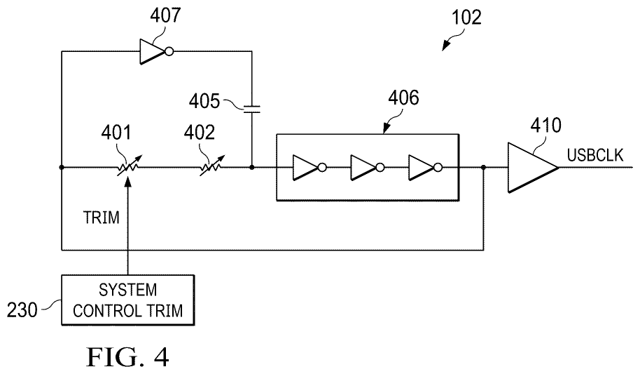

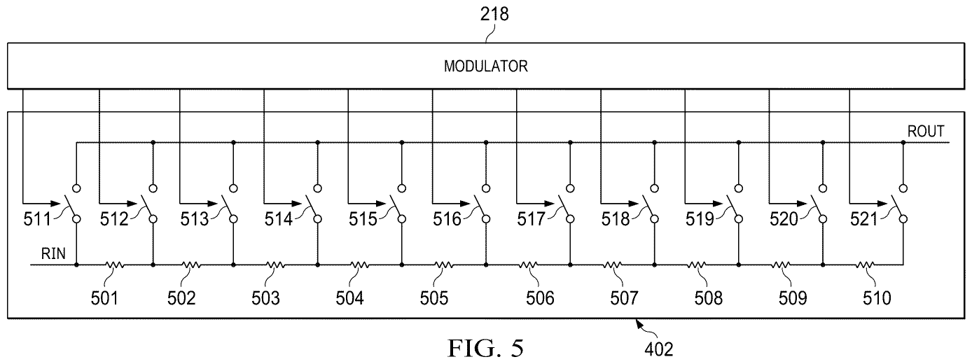

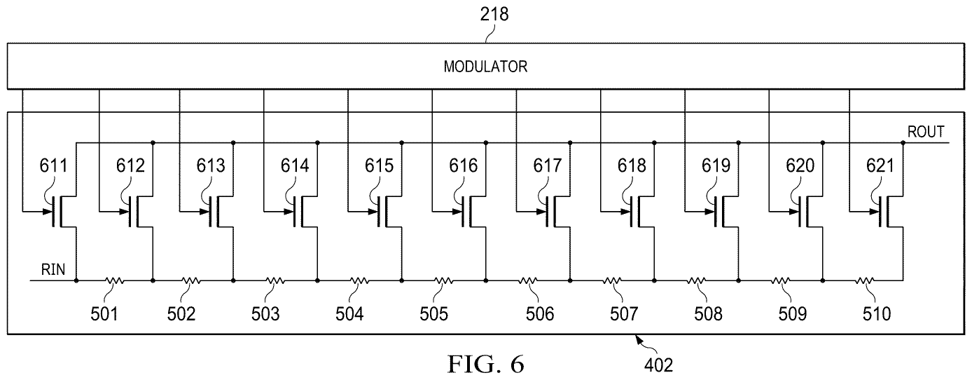

The modulator 218, the oscillator 102, and a system control trim unit 230 are described in more details with FIG. 4, FIG. 5, and FIG. 6 in accordance with many embodiments of this disclosure. FIG. 4, FIG. 5, and FIG. 6 illustrates details of example structures of the oscillator 102, how the modulator 218 adjusts the frequency of the USBCLK generated by the oscillator 102 by modulating control signals sent to the oscillator 102 in response to different offsets received from the offset circuit 216, and the determining factors for the frequency adjustment step of the oscillator 102.

In many embodiments, the oscillator 102 may be a Resistor-Capacitor (RC) oscillator, which includes variable resistors 401 and 402, a capacitor (or a set of capacitors) 405, a set of feedback inverters 406 coupled in a ring and having a number of inverters selected to cause the output of the final inverter of the feedback inverters 406 to oscillate, and a control inverter 407 as shown in FIG. 4. The structure of the variable resistors 401 and 402 are described in more details later. The capacitor 405 may charge (rising edge of an oscillating signal) and discharge (falling edge of the oscillating signal) to generate the oscillating signal. The control inverter 407 may alternate the state of the capacitor between charging and discharging. The resistance of the variable resistors 401 and 402 and the capacitance of the capacitor 405 may determine the time it takes for the capacitor 405 to be charged and/or discharged and, by extension, the amount of time it takes for the input of the first feedback inverter of the feedback inverters 406 to rise and/or fall. Thus, the resistors 401 and 402 and capacitor 405 may determine the frequency of the oscillating signal (the frequency of the USBCLK). The oscillator 102 may further include a buffer 410 that may receive the oscillating signal and output the USBCLK. In other embodiments, the oscillator 102 may include other combinations of electronic components, such as resistors, capacitors, inverters, and operational amplifiers, and those electronic components may be connected in different configurations to generate the USBCLK of the predetermined frequency.

Process variations (e.g., where in the wafer the device silicon is fabricated) may cause slight parasitic variations in devices. Since the resistance of the variable resistors 401 and 402 and the capacitance of the capacitor 405 may determine the frequency of the USBCLK generated by the oscillator 102, process variations may cause the oscillator 102 to generate the USBCLK of a wide range of frequencies, even though the nominal resistance and capacitance may be designed for the oscillator 102 to generate the USBCLK with the predetermined frequency. For example, if the nominal resistance and capacitance as designed for the oscillator 102 generates the USBCLK of 60 MHz, process variations may cause the oscillator 102 of the USB device 200 to generate the USBCLK with a frequency ranging from 35.6 MHz to 90 MHz.

To address this problem, manufacturers may run production tests on devices to check for defects and further trim those devices to compensate for process variances and other imperfections during the fabrication process before shipping those devices to end users. Trimming the devices may involve measuring certain functions (e.g., measuring the frequency of the USBCLK generated by the oscillator 102) of a device during production tests. Based on the performance of the device under test, certain parameters of the device may be adjusted to correct the deviations from the desired performances during the trimming process. The parameters may be adjusted by using fuses, flash memories, one-time programmable (OTP) memories or any other electrical or magnetic storage media.

FIG. 2 and FIG. 4 illustrate examples with a system control trim unit 230 included in the USB device 200 for trimming process during production tests at the manufacturer. The system control trim unit 230 may trim the USB device 200 by adjusting the resistance of the variable resistor 401 according to measured frequency of the USBCLK generated by the oscillator 102. For example, the variable resistor 401 may include a set of resistors connected to a set of fuses. The resistance of the variable resistor 401 may be adjusted by blowing a subset of the set of fuses. Instead of fuses, the variable resistor 401 may also include other structures, such as an OTP memory connected to a set of resistors. The resistance of the variable resistor 401 may be adjusted based on the content of the OTP memory. In some other embodiments, the desired resistance of the variable resistor 401 may be stored in a flash memory, and when the USB device 200 powers up, the desired resistance of the variable resistor 401 may be forwarded to trim registers to adjust the variable resistor 401 accordingly. In other embodiments, other methods of adjusting the resistance of the variable resistor 401 may be implemented.

After the devices are trimmed at the manufacturer during production tests, the resistance of the variable resistor 401 may be set and the oscillator 102 may generate the USBCLK with better accuracy. However, environmental variations, such as temperature, may affect parameters of the components of the oscillator 102, thus drifting the predetermined frequency of the USBCLK. Capacitors also degrade over time, thus may further drift the USBCLK from operating at the predetermined frequency. During the production tests, the devices may just be fabricated, so capacitor may not have degraded. Production tests of the devices may also run in a laboratory with controlled environment (e.g., room temperature). The oscillator 102 in a trimmed USB device 200 may still not generate the USBCLK with an accurate enough frequency to be USB 2.0 compliant. For example, the USBCLK of 60 MHz generated by the oscillator 102 after trimming may have an accuracy range of −6% to 2.2%.

To further adjust and compensate for the effects of environmental variations have on the frequency of the USBCLK generated by the oscillator 102, the resistance of the variable resistor 402 may be adjusted in real time by the modulator 218.

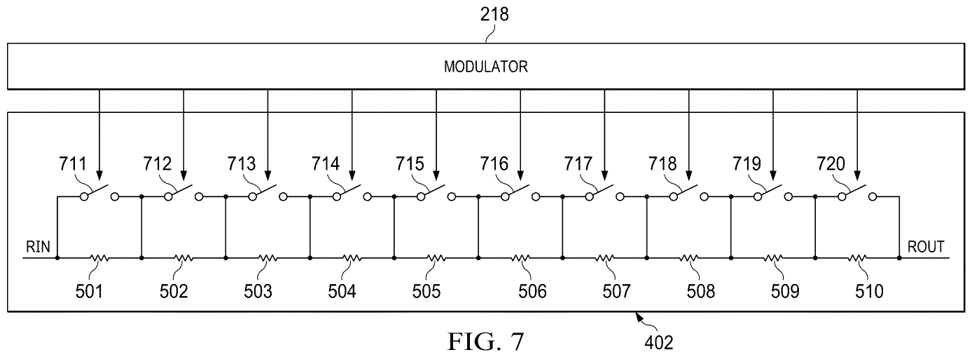

In some embodiments, the variable resistor 402 may be implemented using a thermometric encode configuration shown in FIG. 7. The variable resistor 402 may include a chain of resistors 501-510 coupled to a chain of switches 711-720 as shown in FIG. 7. The chain of resistors 501-510 may be coupled serially. Each resistor may couple to a switch in parallel. Closing a switch may short the respective resistor coupled in parallel. The number of closed switches may determine the resistance of the variable resistor 402. For example, each one of the resistors 501-510 may have a resistance of R. If the desired resistance of the variable resistor 402 is 7R, the modulator may send control signals to close any 3 switches. If all switches are closed, the resistance of the variable resistor 402 may be minimal, close to 0 and if all switches are open, the resistance of the variable resistor 402 may be 10R.

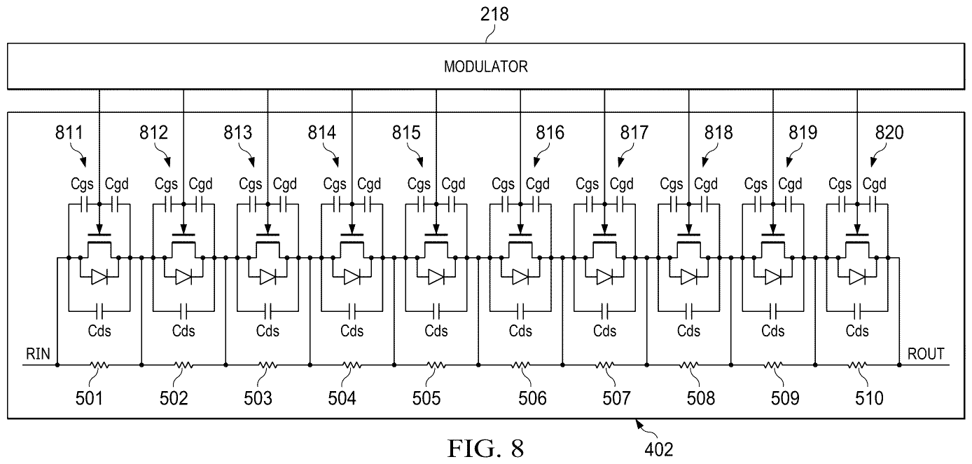

Transistors (e.g., metal-oxide-semiconductor field-effect transistors (MOSFETs)) or other electronic components may be implemented as switches. In other examples, other types of transistors, such as bipolar junction transistors, or other electronic components (e.g., relays) that may act as switches, may be implemented. FIG. 8 illustrates MOSFETs 811-820 implemented as switches 711-720. The MOSFETs 811-820 are shown in FIG. 8 with inherent parasitic capacitance (e.g., Cgs, Cgd, and Cds). One limitation of the thermometric encode scheme as shown in FIG. 8 may be that when the desired resistance of the variable resistor 402 is small, a large number of the MOSFETs may be turned on, adding parasitic capacitance and resistance to the variable resistor 402. Since the frequency of the USBCLK generated by the oscillator 102 may be determined by the variable resistor 401 and 402, parasitic capacitance and resistance from the variable resistor 402 may impact the frequency of the USBCLK generated by the oscillator 102. In addition, parasitic capacitance and resistance from the MOSFETs 811-820 may impact the desired linear resistance change of the variable resistor 402 when opening and/or closing certain number of the MOSFETs 811-820.

FIG. 5 shows another example structure of the variable resistor 402 and how the modulator 218 may adjust the resistance of the variable resistor 402 in accordance with many embodiments of this disclosure. As shown in FIG. 5, the variable resistor 402 may include a chain of resistors 501-510 coupled to a chain of switches 511-521. The chain of resistors 501-510 and the chain of switches 511-521 may be arranged in a configuration different than the configuration shown in FIG. 7. The resistors 501-510 may be coupled serially, and the two terminals of each resistor may be coupled to 2 switches and 2 adjacent resistors. For example, one terminal of the resistor 509 is coupled to the resistor 508 and the switch 519 and the other terminal of the resistor 509 is coupled to the resistor 510 and the switch 520. With this configuration, the first switch closed in the chain of resistors 501-510 may determine the resistance of the variable resistor 402. For example, each one of the resistors 501-510 has a resistance of R. If the switch 518 is closed, the resistance of the variable resistor 401 may be the sum of resistance of all resistor 401-407 (7R). However, closing any or all of the subsequent switches 519-521 in the chain may not change the resistance of the variable resistor 401. If the switch 517 and 518 are closed, the resistance of the variable resistor 401 may be the sum of resistance of all resistors 501-506 (6R). Even though the switch 518 is also closed, the switch 517 determines the resistance of the variable resistor 402. If the first switch 511 is closed, the resistance of the variable resistor 402 may be close to 0. If none of the switches are closed, the resistance of the variable resistor 402 may be infinite (equivalent as an open circuit). 11 switches and 10 resistors are implemented in embodiments shown in FIG. 5. In other examples, any number of resistors and switches may be implemented. Embodiments shown in FIG. 5 include resistors with the same resistance R, but in other embodiments, each resistor in the chain of resistors may have different resistance values.

The modulator 218 may send control signals to open or close the switches 511-521 to adjust resistance of the variable resistor 402. The switches 511-521 may be implemented using a transistor (e.g., a MOSFET) as shown in FIG. 6. Embodiments shown in FIG. 6 includes N-channel MOFSETs 611-621. In examples shown in FIG. 6, the modulator 218 may couple to the gate of each of the MOSFETs 611-621. Depending on the desired resistance of the variable resistor 402, the modulator 218 may send a 1 to the gate of a selected MOSFET on the respective control signal to turn the selected MOSFET on. Using the example above where each one of the resistors 501-510 has a resistance of R, if the desired resistance of the variable resistor 402 is 7R, the modulator 218 may send a 1 to the gate of the MOSFET 618 to turn the MOSFET 618 on (equivalent as closing the switch 518). If the desired resistance of the variable resistor 402 changes to 9R later on, the modulator 218 may send a 0 to the gate of the MOSFET 618 to turn the MOSFET 618 off (equivalent of open the switch 518) and send a 1 to the gate of the MOSFET 620 to turn the MOSFET 620 on to change the resistance of the variable resistor 402 to 19R.

MOSFETs may have a turn-on time and a turn-off time. When the modulator 218 send a 0 to one of the MOSFETs 611-621 and send a 1 to another one of the MOSFETs 611-621, the MOSFET turning off may have been turned off, while the MOSFET turning on may not have been turned on for a brief period of time. For this brief period of time when no MOSFETs are on, the variable resistor 402 may have an infinite resistance. The oscillator 102 may momentarily stop working and the charging and discharging cycles of the capacitor 405 may be disrupted, thus resulting in a disrupted USBCLK.

To solve this limitation, a two-hot encode scheme may be used. In a steady state, a first one of the MOSFETs 611-621 is turned on and governs the current path and in turn governs the resistance of the variable resistor. A second one of the MOSFETS 611-621 may also be turned on, but with little effect on the resistance of the variable resistor as any resistors 501-510 between the first “on” MOSFET and the second “on” MOSFET are effectively short circuited. When transitioning, one of the “on” MOSFETs 611-621 remains on while a second of the “on” MOSFETS is turned off and while a third of the MOSFETS is transitioned from off to on. During the transition, the first MOSFET being on prevents a large jump in the variable resistance of variable resistor 402. Using the example above where each one of the resistors 501-510 has a resistance of R, if the desired resistance of the variable resistor 402 is 7R, the modulator 218 may send a 1 to the gate of the MOSFET 618 and a 1 to the gate of the MOSFET 620 to turn both the MOSFET 618 and 620 on. If the desired resistance of the variable resistor 402 changes to 6R subsequently, the modulator 218 may send a 0 to the gate of the MOSFET 620 to turn the MOSFET 620 off and send a 1 to the gate of the MOSFET 617 to turn the MOSFET 617 on. In this example, the MOSFET 618 may be on throughout the resistance change of the variable resistor 402. Even if the MOSFET 617 and 619 may both be off during a brief period of time, the resistance of the variable resistor 402 may be 7R during that brief period of time, which has no effect on the oscillator 102.

Using the same example as above where each one of the resistors 501-510 has a resistance of R, the step of resistance adjustment of the variable resistor 402 may be R. The resistance of the variable resistor 402 may increment or decrement by R in the range of 0-10R. Since the resistance and capacitance of the RC circuit determines the frequency of the USBCLK the oscillator 102 generates, the step of resistance adjustment of the variable resistor 402 may determine the frequency adjustment step. To have a small frequency adjustment step, the resistance of each one of the resistors 501-510 may be small. However, the total resistance of the chain of resistors 501-510 may determine the range of the frequency adjustment. For example, if resistance R is too small and the frequency of the USBCLK generated by the oscillator is significantly faster than the predetermined frequency, the variable resistor 402 may be adjust to the max resistance available (e.g., 10R), but still may not slow the USBCLK down enough to meet the accuracy requirement as defined in the USB 2.0 specification. Resistors in devices may take up valuable device space and routing individual control signals from the modulator 218 to each gate of the MOSFETs complicates device structure. The number of resistors included in the variable resistor 402 may also be limited due to considerations described above. Therefore, the frequency adjustment step may be limited due to the step of resistance adjustment of the variable resistor 402, which may further limit the accuracy of the frequency of the USBCLK.

As described above, the modulator 218 may receive an offset from the offset circuit 216 and modulate control signals accordingly to adjust the frequency of the USBCLK. The modulator 218 may adjust the frequency of the USBCLK by opening and/or closing a set of switches accordingly. Using the example embodiments shown in FIG. 5 where two-hot encode scheme may be used for adjusting resistance of the variable resistor 402, the variable resistor 402 may have a resistance ranging from 0-10R depending on which switches are closed. When the USB device 200 first powers up, the modulator 218 may send a control signal to close the switch 516 and another control signal to close the switch 518 to select 5R (midpoint of the resistance range) as the starting resistance for the variable resistor 402. Alternatively, the modulator 218 may select the starting resistance of the variable resistor 402 according to the range of the frequency of the USBCLK after trimming. For example, if the frequency of the USBCLK may have a range from −6% to 2.2% after trimming (e.g., adjusting the variable resistor 401) and the final adjusted frequency of the USBCLK may be in a range of +/−0.6% from the predetermined frequency, the modulator may select a smaller starting resistance of the variable resistor 402 since the starting frequency of the USBCLK generated by the oscillator 102 after trimming may have a higher chance of being slower than the predetermined frequency. The modulator 218 may select the starting resistance of the variable resistor 402 to be 3R by sending a control signal to close the switch 514 and another control signal to close the switch 516.

The USBCLK with the starting frequency generated by the oscillator 102 may be provided to the counter 210, and based on how deviated the USBCLK may be from the predetermined frequency, a first offset generated by the offset circuit 216 may be provided to the modulator 218. The offset may be a multiple of oversampling rate (e.g., 5, 10). The offset may not be a multiple of oversampling rate (e.g., 2, 6). The modulator 218 may send control signals to change the resistance of the variable resistor 402 according to the offset, but not modulate the frequencies of the cycles within the modulation window when the offset is a multiple of oversampling rate. When the offset is not a multiple of oversampling rate, the modulator 218 may send control signals to modulate the frequencies of the USBCLK cycles within the modulation window. In some embodiments, the modulator 218 may include a fine-trim value indicating what resistance is desired for the variable resistor 402. The modulator 218 may also include a modulation value indicating the modulation pattern desired. Depending on the offset received, the modulator 218 may update the fine-trim variable and/or the modulation variable accordingly.

For example, if the first offset is 2 (not a multiple of oversampling rate) and the starting resistance of the variable resistor 402 is 5R (switch 516 and 518 closed), the modulator 218 may have an initial fine-trim value of 5 and an initial modulation value of 0. Upon receiving the first offset, the modulator may update the modulation value to 2 (assuming the starting value of the modulation value is 0) indicating 2 cycles within the modulation window may be modulated. The modulator 218 may send control signals to adjust the resistance of the variable resistor to be 6R for 2 cycles within a modulation window (5 cycles of the USBCLK), and the resistance of the variable resistor to be 5R for the rest 3 cycles within the modulation window. The resultant waveform is shown as waveform 316 in FIG. 3. Before the modulation window starts, the modulator 218 may keep the control signal sent to the switch 516 at 1 and the control signal sent to the switch 518 at 1 to keep both switches closed (5R of variable resistor 402). When cycle 0 of the modulation window starts, the modulator 218 may change the control signal sent to the switch 516 from 1 to 0 to open the switch 516, send a 1 on the control signal sent to the switch 517 to close the switch 517, and still keep the control signal sent to the switch 518 at 1 to keep the switch 518 closed. The modulator 218 may keep the switch 517 closed for the first 2 cycles in the modulation window, and when the third cycle starts, the modulator 218 may open the switch 517 and close the switch 516 till the end of the modulation window. The modulator 218 may repeat the above patterns of alternating closing and opening the switches 516 and 517 while the switch 518 may be closed until the modulator 218 receives an offset of different value from the offset circuit 216.

When the offset received by the modulator 218 is a multiple of the oversampling rate, the variable resistor 402 may change base resistance while keeping the modulation pattern from previous cycles. Continuing with the example above, if the second offset received by the modulator 218 is 10 (multiple of 5, where 5 is the oversampling rate), the modulator 218 may update the fine-trim value from 5 to 7 (2 times the oversampling rate) and keep the modulation value at 2. The modulator 218 may send control signals to adjust base resistance of the variable resistor 402 from 5R to 7R. Upon receiving the second offset of 10, the modulator 218 may send control signals to close the switch 520 and to keep the switch 518 closed. Since the modulation value remains unchanged at 2 when the second offset is received, the modulator 218 may continue to alternate closing and opening the switches 518 and 519 while keeping the switch 520 closed. In this regard, the base resistance of the variable resistor 402 may be changed from 5R to 7R, and the modulation pattern from the previous offset remains intact (e.g., 2 cycles of 8R, and 3 cycles of 7R within the modulation window).

In embodiment where the two-hot encode scheme is implemented, the modulator 218 may select which switches to close based on the desired resistance of the variable resistor 402 and the max offset value. Using the same examples as described above, the offset circuit 216 may provide offsets in a range of −10 to 10. As described above and shown in FIG. 5, the modulator 218 may change the resistance of the variable resistor 402 by 2R when an offset of 10 or −10 is received. The modulator 218 may not change the resistance of the variable resistor 402 exceeding 2R due to the max offset value of 10. Accordingly, the modulator 218 may close a first switch that selects the desired resistance of the variable resistor 402 and close a second switch that may be the second subsequent switch down the chain of the resistors 501-510 from the first switch. For example, if 5R is the desired resistance of the variable resistor 402, the modulator 218 may close the switch 516 to select 5R, and also close the switch 518 (the second subsequent switch down the chain of resistors), which has no effect on the resistance of the variable resistor 402 when the switch 516 is closed. When the modulator 218 may close switches in this manner, if a negative offset is received by the modulator 218, switches 515 and 514 before the switch 516 may be closed and the switch 518 may be opened by the modulator 218 while the switch 516 may be kept closed. Since the max offset value may be 10, the modulator 218 may receive any offset values (−1 to −10) and open and/or close the switches 514 and 515 to achieve the desired resistance of the variable resistor 402 while keeping the switch 516 closed. If a positive offset is received (range from 1 to 10), the modulator 218 may alternate closing and opening the switches 516 and 17 while keeping the switch 518 closed to achieve the resistance of the variable resistor 402. The offset circuit 216 described in above examples may have a max offset value of 10, but in other examples, the offset circuit 216 may have any appropriate max offset values, and the modulator 218 may select two respective switches to close accordingly.

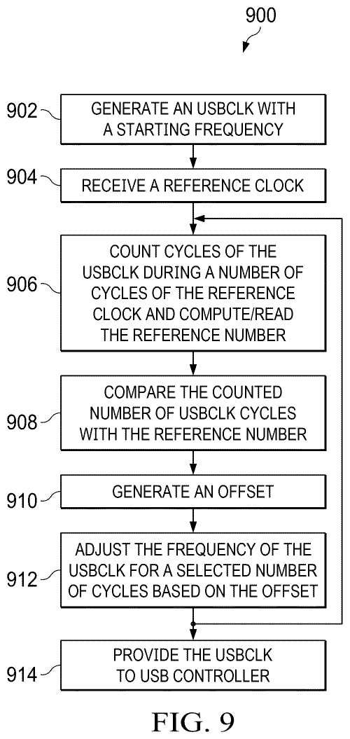

FIG. 9 illustrates a flow chart of a method 900 for improving clock accuracy generated by an oscillator. Method 900 may be performed by the USB device 100 and/or the USB device 200 as illustrated in FIG. 1-FIG. 8. The method described herein may include more, fewer, or other blocks. Additionally, the blocks may be performed in any suitable order. The method 900 may start at block 902.

At block 902, the oscillator 102 may generate the USBCLK with a starting frequency. Since the oscillator 102 may be a RC oscillator, which includes variable resistors 401 and 402, and a capacitor 405, the resistance of the variable resistors 401 and 402, and the capacitance of the capacitor 405 may determine the frequency of the USBCLK generated by the oscillator 102. Due to process variations, environmental factors, and other imperfections, even though the oscillator 102 may be designed to generate the USBCLK with a predetermined frequency, the oscillator 102 may generate the USBCLK with the starting frequency, where the starting frequency may be different from the predetermined frequency. The resistance of the variable resistor 401 may be set during the trimming process (production tests at the manufacturer) as described above so the starting frequency may not deviate greatly from the predetermined frequency. When the USB device 100 and/or 200 is powered up, the oscillator 102 may generate the USBCLK with the starting frequency with the initial resistance of the variable resistor 402.

At block 904, the feedback circuit 105 may receive a reference clock (REFCLK) either derived from the SOF packets sent by the USB host 110 or derived from other clock sources internal or external to the USB device 200 as described above. The clock sources may provide clocks with fixed frequency or programmable frequencies. The different clock sources may provide clocks to the mux 205, and the USB controller 104 or other control units in the USB device 200 may send the select signal to select a clock from the desired clock source for REFCLK.

At block 906, the counter 210 may receive the USBCLK with the starting frequency generated by the oscillator 102 and the REFCLK. The counter 210 may use a number of cycles of the REFCLK as a reference time window and count how many USBCLK cycles have elapsed during the reference time window. The computing circuit 217 may compute the reference number based on the frequency of the REFCLK, the predetermined frequency of the USBCLK, and the number of cycles of the REFCLK in the reference time window and may store the reference number in the memory 204 as described above. The predetermined frequency of the USBCLK may also be programmable. For example, the USB controller 104 may change speed, e.g., from full speed to low speed, or from full-speed to high-speed during operation. The predetermined frequency of the USBCLK may change accordingly, and so the reference number may also change accordingly. The USB controller 104 or other control units may also change oversampling rate during operation, and the predetermined USBCLK may change accordingly. Alternatively, the computing circuit 207 may not compute the reference number when the reference number is a fixed number. The reference number may be a fixed number (not programmable) if the REFCLK may have a fixed (not programmable) frequency, the number of cycles of the REFCLK within the reference time window may also be a fixed number, and the predetermined frequency of the USBCLK may not be programmable. The fixed reference number may be stored in a memory 203 and not computed by the computing circuit 207. For example, the reference number may be 60,000 when the REFCLK may be of 1 kHz frequency derived from the SOF packets, the reference time window may be 1 cycle of the REFCLK (1 ms), and the predetermined frequency of the USBCLK may be 60 MHz. In embodiments where the REFCLK is selected through the mux 205 from multiple clock sources, the respective reference number for each clock source may also be provided to the mux 206. The USB controller 104 or other control units in the USB device 200 may forward the select signal sent to the mux 205 to the mux 206 to select the respective reference number to be forwarded to the comparator 214.

Method 900 may continue to block 908. At block 908, the counted number of cycles of the USBCLK during the reference time window may be compared to the reference number. The difference between the counted number of cycles of the USBCLK during the reference time window and the reference number may indicate how deviated the starting frequency of the USBCLK may be from the predetermined frequency. The comparator 214 may compute an integer by subtracting the reference number from the counted number of cycles of the USBCLK. A positive integer may indicate the starting frequency is higher than the predetermined frequency (the USBCLK is faster than desired), and a negative integer may indicate that the starting frequency of lower than the predetermined frequency (the USBCLK is slower than desired). The magnitude of the integer may indicate how deviated the starting frequency of the USBCLK may be from the predetermined frequency.

Method 900 may continue to block 910. At block 910, the comparator 214 may provide the integer to the offset circuit 216 to generate an offset to provide to the modulator 218. The offset may be generated based on the sign and the magnitude of the integer. The offset may be a negative number if the integer has a negative sign, and the offset may be a positive number if the integer has a positive sign. The magnitude of the offset may be computed based on the offset step, which may be based on the equivalent frequency adjustment step and the reference number. Since the modulator 218 may adjust the frequency of a number of USBCLK cycles within a modulation window, the equivalent frequency adjustment step of the USBCLK may be the frequency adjustment step of the oscillator 102 divided by the oversampling rate of the USB controller 104 as described above. The offset step, which indicates in terms of cycles of how deviated the starting frequency of the USBCLK is from the predetermined frequency, may be computed by multiplying the reference number with the equivalent frequency adjustment step. For example, if the oversampling rate of the USB controller 104 is 5, the modulator 218 may adjust the frequency of 0-5 cycles of the USBCLK within a modulation window (5-cycle USBCLK time period). If the frequency adjustment step of the oscillator 102 is 0.6%, the equivalent frequency adjustment step of the USBCLK may be 0.12%. If the reference number is 60,000, the offset step may be 60,000×0.12%, which is 72 cycles. The offset step may in turn determine the accuracy range of the adjusted frequency of the USBCLK, which in this example, may be +/−0.06% (0.12% divided by 2) or +/−36 cycles. When the magnitude of the integer is less than 36, the offset circuit 216 may provide an offset of 0 to the modulator 218, indicating no further adjustment. The accuracy range of the adjusted USBCLK may be within +/−0.06% (36 cycles, 72 cycles divided by 2). The magnitude of the offset may be determined based on the offset step. The offset may be the quotient of adding half of the offset step to the magnitude of the integer and then divided by the offset step. For example, if the integer received from the comparator 214 is −128, the magnitude of the offset may be the quotient of (128+72/2)/72, which is 2. Since the integer is a negative number, the negative sign may be added to the offset, the offset in this case may be −2. Alternatively, a lookup table may be created to look up the offset value based on the magnitude of the integer received as described above. In other embodiments, the simplified algorithm for computing and providing offsets may be implemented as described above.

Method 900 may continue to block 912. At block 912, the modulator 218 may receive the offset from the offset circuit 216 and adjust the starting frequency of the USBCLK accordingly. The oscillator 102 may have different resistor, capacitor, and switches configurations. The frequency of the USBCLK generated by the oscillator 102 may be determined by the resistance of the variable resistors 401 and 402. The resistance of the variable resistor 401 may be set after the trimming process. The modulator 218 may adjust the resistance of the variable resistor 402 in the oscillator 102 to adjust the frequency of the USBCLK. The modulator 218 may adjust the resistance of the variable resistor 402 by opening and/or closing a number of switches to select the desired resistance of the variable resistor 402. The modulator 218 may further modulate the frequency of a number of cycles within the modulation window to achieve an equivalent frequency adjustment step smaller than the frequency adjustment step of the oscillator 102, and thus better accuracy may be achieved for the final adjusted frequency of the USBCLK as described in details above.

The USBCLK after adjustment may be provided back to the feedback circuit 105. If the frequency of the USBCLK after the first adjustment is still deviated from the predetermined frequency, blocks 906 through 912 may be repeated until the offset value of 0 may be provided to the modulator 218. Alternatively, the USBCLK may continuously be provided back to the feedback circuit, and blocks 906-912 may continuously be repeated as long as the USB device 100 and/or 200 may be powered up and running. In this regard, the USBCLK may be constantly monitored and adjusted when environmental variations, such as temperature change, may cause the USBCLK to deviate from the predetermined frequency.

Method 900 may continue to block 914. At block 914, the oscillator 102 may provide the USBCLK generated to the USB controller 104. The USB controller 104 may then use the USBCLK to time the transmission of packets, to sample received packets, and to perform other communication tasks. In embodiments where the USBCLK may be continuously fed back to the feedback circuit 105 and blocks 906-912 may continuously be repeated, the oscillator 102 may continuously provide the USBCLK to the USB controller 104. The USB controller 104 may have 60 ms of startup time before the USB controller 104 may send USB-compliant packets to the USB host 110. Method 900 may achieve the desired accuracy of the USBCLK within 10 ms. The starting frequency of the USBCLK may deviate from the predetermined frequency and the USB controller 104 may not send USB-compliant data packets to the USB host 110 during the first 10 ms. But as long as the USB controller 104 may send USB-compliant data packets to the USB host 110 after the first 10 ms, the USB communications between the USB device 100 and/or 200 and the USB host 110 may still be USB-compliant. Alternatively, the USB controller 104 may not utilize the USBCLK with the starting frequency generated by the oscillator 102. The modulator 218 or the offset circuit 216 or other control units in the USB device 100 and/or 200 may send a clock good signal to the USB controller 104 when the offset is 0 to indicate to the USB controller 104 that the USBCLK generated by the oscillator 102 may be USB-compliant. Upon receiving a 1 on the clock good signal, the USB controller 104 may utilize the USBCLK for data packet transmission and reception. If environmental variations may drift the USBCLK from the predetermined frequency, the modulator 218, or the offset circuit 216, or other control units in the USB device 100 and/or 200 may change the 1 on the clock good signal to a 0 when a non-0 offset is received/generated. The USB controller 104 may receive the 0 on the clock good signal and stop using the USBCLK for data packet transmission and reception until the USBCLK is brought back into specification.

This invention disclosure is described with the context of providing a USB 2.0 compliant clock to a USB controller in a USB device. The example devices/systems and methods described above may also be implemented in other fields. Any applications that may include a low cost, non-crystal oscillator may benefit from the invention disclosure that improves accuracy of the clock generated by the oscillator.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

What is claimed is:

1. A device, comprising:
a first circuit configurable to provide a first clock;
an oscillator configurable to provide a second clock;
a memory configurable to store a first number; and
a second circuit coupled to the first circuit, the oscillator, and the memory, wherein the second circuit is configurable to:
receive the first clock and the second clock;
count a second number of clock cycles of the second clock during a time period, wherein the time period is based on the first clock;
determine a difference between the first number and the second number; and
adjust a duration of a set of clock cycles of the second clock based on the difference.

2. The device of claim 1, wherein the oscillator comprises:
a set of resistors;
a set of switches coupled to the set of resistors; and
a capacitor coupled to the set of switches.

3. The device of claim 2, wherein the set of switches comprises transistors.

4. The device of claim 2, wherein the second circuit is configurable to adjust the duration of the set of clock cycles of the second clock by opening and closing a subset of the set of switches.

5. The device of claim 4, wherein the set of clock cycles of the second clock is a first set of clock cycles, and wherein the second circuit is configurable to adjust the duration of the first set of clock cycles of the second clock by:
causing a first switch of the subset of the set of switches to be in a closed state during the first set of clock cycles of the second clock;
causing the first switch to be in an open state during a second set of clock cycles of the second clock;
causing a second switch of the subset of the set of switches to be in a closed state during the second set of clock cycles of the second clock; and
causing a third switch of the subset of the set of switches to be in a closed state during the first set of clock cycles of the second clock and the second set of clock cycles of the second clock.

6. The device of claim 1, wherein the first circuit is configurable to receive Start of Frame packets and provide the first clock based on the Start of Frame packets.

7. The device of claim 1, wherein the first number is determined based on a predetermined frequency of the second clock and the time period.

8. The device of claim 1, wherein the oscillator is a non-crystal oscillator.

9. The device of claim 1, wherein:
the oscillator is a first oscillator,
the first circuit comprises a second oscillator, and
the second oscillator is configurable to generate the first clock.

10. A method, comprising:
receiving a first clock;
generating a second clock by an oscillator;
reading a first number stored in a memory;
counting a second number of clock cycles of the second clock during a time period, wherein the time period is based on the first clock;
determining a difference between the first number and the second number; and
adjusting a duration of a set of clock cycles of the second clock based on the difference.

11. The method of claim 10, wherein the oscillator comprises:
a set of resistors;
a set of switches coupled to the set of resistors; and
a set of capacitors coupled to the set of switches.

12. The method of claim 11, wherein the set of switches comprises transistors.

13. The method of claim 11, wherein the adjusting of the duration of the set of clock cycles comprises opening and closing a subset of the set of switches.

14. The method of claim 13, wherein the set of clock cycles of the second clock is a first set of clock cycles of the second clock, and wherein adjusting the duration of the first set of clock cycles comprises:
operating a first switch of the subset of the set of switches in a closed state for the first set of clock cycles of the second clock;
operating the first switch in an opened state for a second set of clock cycles of the second clock;
operating a second switch of the subset of the set of switches in a closed state for the second set of clock cycles of the second clock; and
operating a third switch of the subset of the set of switches in a closed state for both the first set of clock cycles and the second set of clock cycles.

15. The method of claim 10, wherein the first clock is derived from Start of Frame (SOF) packets.

16. The method of claim 10, wherein the first number is determined based on a predetermined frequency of the second clock and the time period.

17. The method of claim 10, wherein the oscillator is a non-crystal oscillator.

18. The method of claim 10, wherein the oscillator is a first oscillator, and the method comprising: generating the first clock by a second oscillator.

19. A system, comprising:
a first circuit configurable to transmit a first signal;
a second circuit comprising:
a detector circuit configurable to receive the first signal and to provide a first clock based on the first signal;
an oscillator configurable to provide a second clock;
a memory configurable to store a first number; and
a control circuit coupled to the detector circuit, the oscillator, and the memory, wherein the control circuit is configurable to:
receive the first clock and the second clock;
count a second number of clock cycles of the second clock during a time period, wherein the time period is based on the first clock;
determine a difference between the first number and the second number; and
adjust a duration of a set of clock cycles of the second clock based on the difference; and
provide data packets to the first circuit based on the adjusted second clock.

20. The system of claim 19, wherein the first signal comprises Start of Frame packets.
